(19) United States
(12) Patent Application Publication
(10) Pub. No.: US 2013/0138507 A1
(43) Pub. Date: May 30, 2013

(54) PREDICTIVE MODELING FOR E-COMMERCE ADVERTISING SYSTEMS AND METHODS

(71) Applicants: Amit Kumar, San Jose, CA (US); Gursharan Singh, Mountain View, CA (US); Andrew Pariser, Palo Alto, CA (US); Santiago Akle, Woodside, CA (US); Ilana Segall, San Francisco, CA (US)

(72) Inventors: Amit Kumar, San Jose, CA (US); Gursharan Singh, Mountain View, CA (US); Andrew Pariser, Palo Alto, CA (US); Santiago Akle, Woodside, CA (US); Ilana Segall, San Francisco, CA (US)

(21) Appl. No.: 13/308,527

(22) Filed: Nov. 30, 2011

(51) Int. Cl. G06Q 30/02

(52) U.S. Cl. 705/14.54

(57) ABSTRACT

Systems and methods for facilitating a predictive advertising campaign are disclosed herein, in one embodiment an advertising analytics server is programmed with a predictive advertising engine and an advertisement personalization engine. The advertising analytics server is communicatively coupled to one or more e-commerce sites, search engines, Web browsers or other Web sites. The advertising analytics server and its constituent components are capable of implementing predictive advertising models and rules that automatically generate advertisements on behalf of e-commerce sites by analyzing data (analytics) from the e-commerce sites or individual consumers. Advertisements are optimally generated for e-commerce businesses based on statistical models that predict consumer behavior, preferences, and likelihood of purchases. Using these models, e-commerce businesses are able to advertise their products and services, bid on key words and target a variety of consumers in a personalized, targeted and cost effective manner, resulting in increased revenue and efficient allocation of marketing resources.

### FIELD OF THE INVENTION

The present invention relates generally to the field of e-commerce systems and

methods, and in particular to automated advertising campaigns modeled on user behavior.

### BACKGROUND

With a variety of products and services available to consumers today, advertising and marketing is central to any business, especially on-line businesses that do not have direct visible interaction with customers. Advertising usually begins with a product, and an advertisement for that product. Traditional methods of advertising include television commercials, billboards, magazine ads and other sources that are likely to be browsed or viewed by the public.

On-line advertising, however, is different. An on-line business that markets or sells a product must have more than a product and potential customers. It must also have on-line visibility, that is, its on-line identity must be known and visible to a potential consumer. In today's digital world, people are spending more time on the internet. Thus, often, an on-line business' most effective source for marketing its products and services is a captive audience on the World Wide Web. An e-commerce business that has identified a product, a target audience, and has procured a Web site for its business must now reach out to millions, if not billions of potential consumers that are rapidly searching the Internet, visiting Web sites, and conducting keyword searches through popular search engines such as Google™, Yahoo™, and Bing™.

Competing for consumers online is a challenging task for any business. Most consumer behavior online involves rapidly moving from one Web site or Web page to the next. Often consumers have limited time or attention spans when browsing Web pages and product shopping on-line can be spontaneous or directly driven by advertising or search results. Online advertising by businesses typically involves purchasing keywords from popular search engines. Depending on the type of service purchased, when a particular key word is searched through a search engine, a business listing or its Uniform Resource Locator (URL) will show up in ranked search results in a user's geographic region. To effect this type of advertising, arc e-commerce business may partner with services such as Google Ads or Yahoo! Ads and purchase certain keywords related to its business in order to draw an automatic association between a searched key word (phrase, etc.) and the corresponding e-commerce business, thus ensuring that the e-commerce business shows up in the displayed results of a search engine Web page. These services often employ a “click through” payment method which charges e-commerce businesses a certain amount each time an Internet user clicks on the URL link of the subscribing e-commerce business. These advertisements are generally known as “Sponsored Ads” and are advertisements placed by the search engines in special advertising areas of the Web page, home page, e-mail in box of the user or another Web page or Web site associated with the search engine.

Another method of on-line advertising by e-commerce businesses entails purchasing on-line real estate. Using this method, an e-commerce business may advertise its products and services through popular third party Web sites such as Facebook™, Groupon™, and home pages of sites such as CNN.com, NYTimes.com, etc. These sites may partner with e-commerce businesses and allow e-commerce ads to be placed on their sites or display pop-tip ads when a user visits the she. This often involves significant time of a marketing department: or employee to identify potential partnering Web sites and enter into agreements with the third parties to display ads on their sites.

Finally, some combination of the above methods may be used where an e-commerce business uses services such as Google or Yahoo! to purchase key words and define a relevant geography, product, and target consumer for its products and services, and also partners with third party sites to obtain on-line commercial real estate for e-commerce business advertisements. However, even with the current slate of options available to e-commerce businesses, e-commerce business owners must spend significant time, resources and capital in creating an advertising campaign, researching the appropriate search engines to use, defining a number of complex variables such as key words, target audience, geography, product category, products, product attributes, etc., and monitor and gather statistics on consumer behavior to determine what types of users and what types of sites are appropriate and effective for their advertisements.

For an e-commerce business with limited funds for online advertising, and with billions of potential Web pages on which to market its products and services, determining how to make best use of limited funds in an efficient and effective manner poses a significant challenge for businesses that greatly impacts the revenue recognition potential of that business. One common and known metric for measuring the success of online advertising is the “conversion rate”. The conversion rate measures the ratio of how many users actually purchased a product on an e-commerce Web site compared to the total number of users that clicked on an advertisement link directing the user to the e-commerce Web site.

$$Conversion rate = \frac{\# of users that clicked on ad}{\# of users that purchased a product}$$

Getting access to “conversation rate” data typically involves the following process: (1) e-commerce business provides key word to search engine; (2) Ad associated with key word is generated; (3) consumer searches key word online; (2) Ad associated with key word is displayed with link to e-commerce business URL: (4) consumer clicks on URL of e-commerce Web site; (5) consumer buys (or does not buy) product online by checking product out of shopping cart; (6) purchase data is provided to the e-commerce business.

This data typically provides an e-commerce business with some way to measure the success of using certain key words. While the “conversion rate” metric provides information to the e-commerce business as to what key words generated the most purchases, it does not reveal other valuable information about the consumer such as which Web page the user came from, the time the user spent on the Web site, which Web pages the user browsed on the e-commerce site, which products the user put into his basket, how much time was spent was spent on particular product pages, etc. The currently available online advertising options do not have the ability to measure and predict online shopping behavior and to use other data points and statistical models to optimize and automate key words and direct advertising to individuals based on models predicting user behavior online. Recognizing the above described limitations with traditional advertising methods, the present inventors have produced an intelligent, automatic system that can generate and optimize advertising for an e-commerce businesses using predictive algorithms and statistical models.

### SUMMARY OF THE INVENTION

An embodiment of the invention includes an automated advertising system. The system includes an advertising analytics server communicatively coupled to one or more e-commerce servers, one or more search engines, one or more Web sites and one or more Web browsers. The advertising analytics server is capable of receiving analytics data from one or more e-commerce servers; wherein said analytics data includes data from the activities of one or more Web browsers. The advertising analytics also includes a predictive ad generating engine programmed with one or more predictive ad generating algorithms. The predictive ad generating engine utilizes analytics data from one or more e-commerce servers and generates on or more ads on behalf of the e-commerce servers using at least one ad generating algorithm. The advertising analytics server causes an ad to be placed on at least one Web browsers,

In one embodiment, the analytics server is coupled to one or more search engines and is able to automatically bid on key words with the search engine on behalf of an e-commerce Web site.

In another embodiment the advertising analytics server contains analytics data and predictive models to classify user behavior. The predictive models may be used by the predictive ad generating engine to create a personalized ad for a Web browser.

In certain embodiments, the advertising analytics server communicates directly with one or more Web sites and causes an ad to be displayed on one or more Web sites that are selected based on a predictive model and a predictive ad generating algorithm.

Another embodiment of the invention includes an automated or partially automated computerized method for effecting advertising over a network. The method may be implemented on one or more servers or computers connected to a network. According to one embodiment, the method includes the steps of: receiving analytics data from one or more e-commerce Web sites; determining whether an ad generating algorithm is available for a given set of analytics data; if an ad generating algorithm is available, selecting at least one ad generating algorithm based on a given set of analytics data; generating an advertisement based on at least one ad generating algorithm; and causing an advertisement to be displayed on at least one Web browser.

In one embodiment, the method includes the step of analyzing analytics data in connection with one or more predictive models before selecting at least one ad generating algorithm that is based on a classification of analytics data to one or more predictive models.

Another embodiment, includes the step of bidding on key words in response to receiving analytics data from one or more e-commerce Web sites.

In other embodiments, the method may personalize the advertisement for the user or Web browser.

Further disclosed herein, is a computerized method of bidding on key words with a search engine. The method may he implemented on one or more servers or computers connected to a network. A method carried out in accordance with this embodiment, may include at least the following steps: monitoring the behavior of users on one or more Web sites; collecting analytics data from based on behavior on one or more Web sites; comparing the user behavior to a predictive model to determine a factor related to products and services; identifying one or more key words based on said factor; and bidding on one or more identified keys words with said search engine.

In one embodiment of automated key word bidding, the method may include the step of optimizing the bid amounts based on a pre-determined advertising budget.

It will be appreciated that the invention is not limited to the embodiments described herein. Although the invention is described with reference to particular embodiments, these descriptions are only examples of the invention's application and should not be taken as limitations. Therefore, various adaptations and combinations of features of the embodiments disclosed are within the scope of the invention as defined by the claims. It should also be noted that embodiments of the present invention have been described with references to various software and hardware components, some of which are depicted in the exemplary figures. One of ordinary skill in the art will recognize that modem distributed computing system allow software and/or hardware components to reside in different locations, servers, clients and/or hardware or firmware components without limiting the location or function of the software, firmware or hardware components as described with reference to the exemplary embodiments and figures.

### BRIEF DESCRIPTION OF THE DRAWINGS

The present invention will be more fully understood from the following detailed description thereof taken together with the accompanying drawings, in which:

FIGS. 1 and 2 are examples of computer architectures for computer systems configured in accordance with embodiments of the present invention.

FIG. 3(a) illustrates components of a network architecture in which embodiments of the present invention may be implemented.

FIG. 3(b) shows an exemplary system implementation according to one embodiment of the invention.

FIG. 4 is allow diagram of a method according to which embodiments of the invention may be implemented.

### DETAILED DESCRIPTION

Embodiments of the present invention relate to automated systems and methods for predicting and modeling user behavior in an e-commerce system and optimizing advertisements for e-commerce businesses and Web Site owners and operators.

The present inventors have recognized that advertising on-line can be a daunting and difficult task. In addition to formulating a marketing campaign and advertisements (“ad” or “ads”) for products and services, an e-commerce Web site operator or on-line business (hereinafter referred to as “e-commerce business”, “merchant” “owner” “operator”) must also establish appropriate channels for the advertisements. Furthermore, once those channels of advertising are identified, the e-commerce business must lake steps to make sure that its Web site and advertisements are generated in search results or appear on affiliated or unaffiliated Web sites where a consumer is likely to view or purchase produces or services advertised by the e-commerce business.

Identifying key words to be used by search engines to generate ads is often a trial and error process. Most businesses do not have the marketing sources to invest in search engine optimization services or to decipher logs of data generated from visits or activity on their Web site. Optimizing factors, such as, which key words to use with search engines, which potential Web sites to use for advertisements, how frequently to advertise, which geographic regions to place ads in and which products to focus advertising dollars, are likely to involve analysis of a substantial amount of data over time. Most e-commerce businesses do not and cannot engage in this manual process due to limited resources or lack of knowledge concerning user behavior and the statistical and mathematical modeling involved in making accurate predictions based on online user activity. Moreover, key word bidding is a competitive process that constantly evolves in response to the popularity of certain products or services. The embodiments of the invention address this and other issues involved in making intelligent advertising decisions.

Accordingly, embodiments of the invention have provided computerized automated systems for creating, generating and placing advertisements on behalf of an e-commerce businesses using methods the optimize the use of advertising dollars and make automatic decisions based on predictive modeling of actual user behavior online.

In one embodiment of the invention, the inventors have disclosed an advertising analytics system that is communicatively coupled to e-commerce Web sites, third party Web sites, search engines, consumer computers and mobile devices, and in general, to the World Wide Web. An e-commerce business seeking to automate and optimize its advertising may register or subscribe to the services of the advertising analytics server. Once registered with the analytics server, the analytics server is able to monitor the activities and transactions that take place on the registered e-commerce Web site, including tracking and monitoring the behavior of individual users that visit a registered e-commerce Web Site. The monitoring may be effected by the placement of cookies or other monitoring files on the e-commerce Web site and the Web browsers of individual consumers visiting a registered Web site or site affiliated with the analytics advertising system.

According to certain embodiments, an advertising analytics server (also referred to as “analytics server”) includes software modules including predictive advertising engines and advertising personalization engines that are used to analyze, compute and generate advertisements based on predictive algorithms and other factors that may be specified by an administrator, merchant or user of the system. The analytics server is capable of storing data on users of registered e-commerce Web sites such as time spent on site, product pages visited, items purchased, etc. The analytics server also contains software modules and routines for calculating the allocation of advertising funds and for generating advertisements based directly on consumer activity. For example, the analytics server may monitor browsing activity on an e-commerce Web site and predict which advertisements and key words would optimally generate revenue for the e-commerce Web site. This may be accomplished, for example, through statistical modeling of consumer behavior online, which may account for such factors as purchasing habits in relation to pages viewed, number of mouse clicks made on any given page, or purchase volume measurements in response to specific ads or promotions.

In one embodiment for modeling consumer behavior, the analytics server may store web browsing and shopping activities with respect lo every user that visits a registered e-commerce site. By tracking all aspects of user behavior such as pages visited, time spent, products placed in shopping cart; and subsequent pages visited, the analytics server is able to profile certain types of users for the registered e-commerce site. The profiles of various consumers and the statistical information gathered by the analytics server can then be used to generate specific predictive algorithms that, are able target advertising not only for a certain type of consumer, but also each consumer individually.

The embodiments of the invention can achieve optimal advertising efficiency by integrating various components of traditional e-commerce systems related to advertising, such as search engines, advertising servers, and third party Web sites that may host and display ads.

The system simplifies the steps that must be taken by an e-commerce business in order to effectively market its products and services. For example, in one embodiment of the invention, an advertising analytics server is able to track and monitor visitors to an e-commerce Web site and give instructions to search engine advertising providers and third party Web sites to display and list ads for the e-commerce business in direct response to visitor activity on-line. The advertising analytics system may use a statistical or hueristic approach with e-commerce businesses to simplify the process. For example, consider the situation where there is a spike in the number of people searching or browsing pages on the Web or an e-commerce site for I-pads™ or Samsung Galaxy™ tablets. The advertising analytics server, according to embodiments of this invention, is capable of registering such activity through direct feedback from affiliated e-commerce Web sites or search engines. In response, the advertising analytics server may implement a predictive model or algorithm that is product or product category sensitive. Thus, it may initiate bidding on key words or automatically begin, placing ads for an e-commerce business that sells tablet computers

In various embodiments of the present invention, owners and operators of e-commerce Web sites may access or register with the advertising analytics server which registration will permit these merchants to set options, get recommendations, for e.g. on specifying advertising budgets from business intelligence models, and change options whenever the merchant may want to modify or optimize the direction and focus of the advertising campaign. The advertising analytics may automatically optimize if the merchant desires that such advertising be operated in “automatic” or “auto-pilot” mode. In this mode, the advertising analytics server may optimize the advertising for the e-commerce merchant based on an analysis of data trends, statistics and predictive algorithms to implement specific advertising strategies.

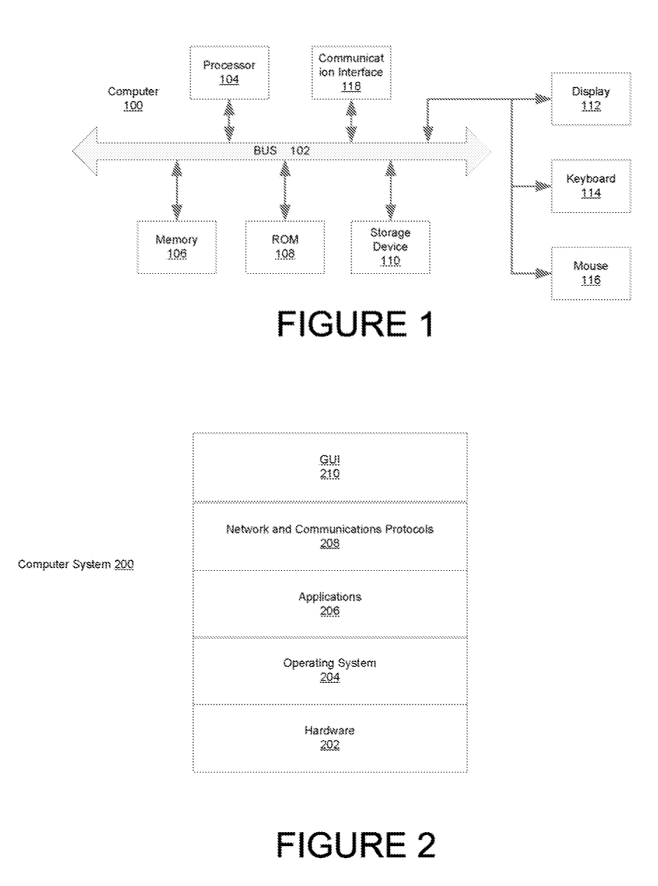

Embodiments of the present invention are discussed below with reference to FIGS. 1-4. The figures are illustrative of certain embodiments of the invention and are not intended to limit the scope of the claimed invention.

FIG. 1 illustrates an example of a computer system 100 on which any of the methods and systems of various embodiments of the present invention may be implemented. Computer system 100 may represent any of the computer systems and computerized methods discussed in connection with FIGS. 2-4 and, in particular, may represent a server, client or other computer system upon which e-commerce servers, Web sites, Web browsers and/or Web analytic applications may be instantiated. Computer system 100 includes a bus 102 or other communication mechanism for communicating information, and a processor 104 coupled with the bus 102 for processing information. Computer system 100 also includes a main memory 106, such as a RAM or other dynamic storage device, coupled to the bus 102 for storing information and instructions (such as instructions for e-commerce rules arid promotions) to be executed by processor 104. Main memory 106 also may he used for storing temporary variables or other intermediate information during execution of instructions to be executed by processor 104. Computer system 100 further includes a ROM 108 or other static storage device coupled to the bus 102 for storing static information and instructions for the processor 104. A storage device 110, such as a hard disk, is provided and coupled to the bus 102 for storing information and instructions (such as computer readable instructions comprising the Web analytics engines, customer information, Web server, and user interfaces for the merchant dashboard).

Computer system 100 may be coupled via the bus 102 to a display 112 for displaying information to a user, however, in the case of servers such a display may not be present and all administration of the server may be via remote clients. Likewise, input device 114, including alphanumeric and other keys, may be coupled to the bus 102 for communicating information and command selections to the processor 104, but such a device may not be present in server configurations. Another type of user input device is cursor control device 116, such as a mouse, a trackball, or cursor direction keys for communicating direction information and command selections to processor 104 and for controlling cursor movement on the display 112. Such an input device may or may not be present in a server configuration.

Computer system 100 also includes a communication interface 118 coupled to the bus 102. Communication interface 118 provides for two-way, wired and/or wireless data communication to/from computer system 100, for example, via a local area network (LAN) or other network, including the Internet. Communication interface 118 sends and receives electrical, electromagnetic or optical signals which carry digital data streams representing various types of information and instructions. For example, two or more computer systems 100 may be networked together in a conventional manner with each using a respective communication interface 118.

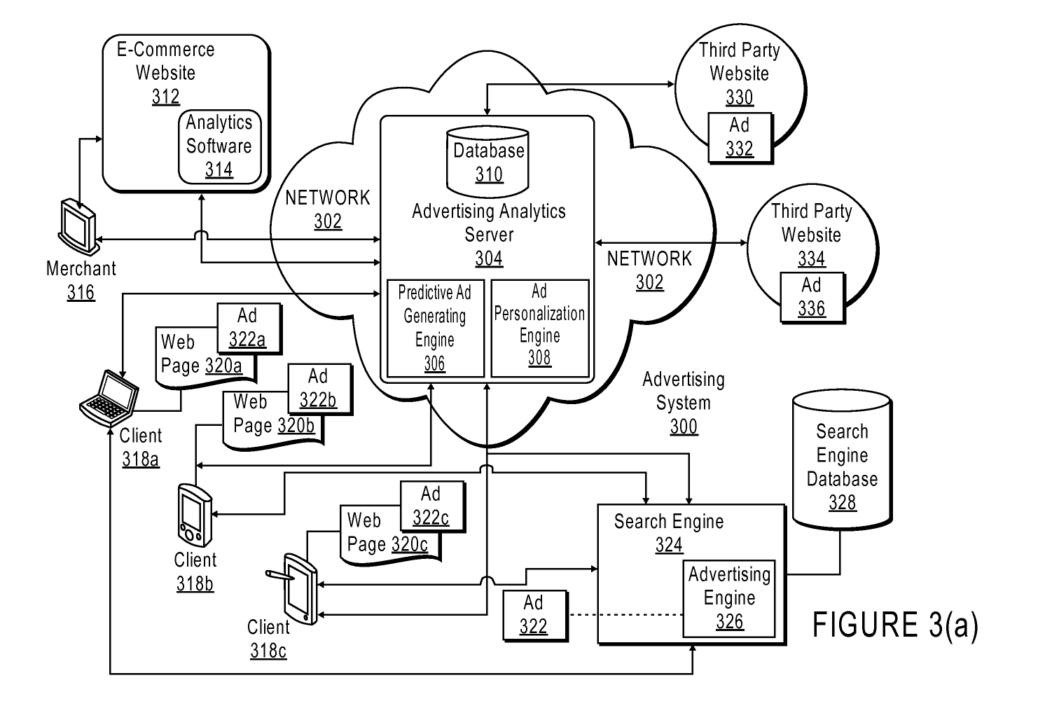

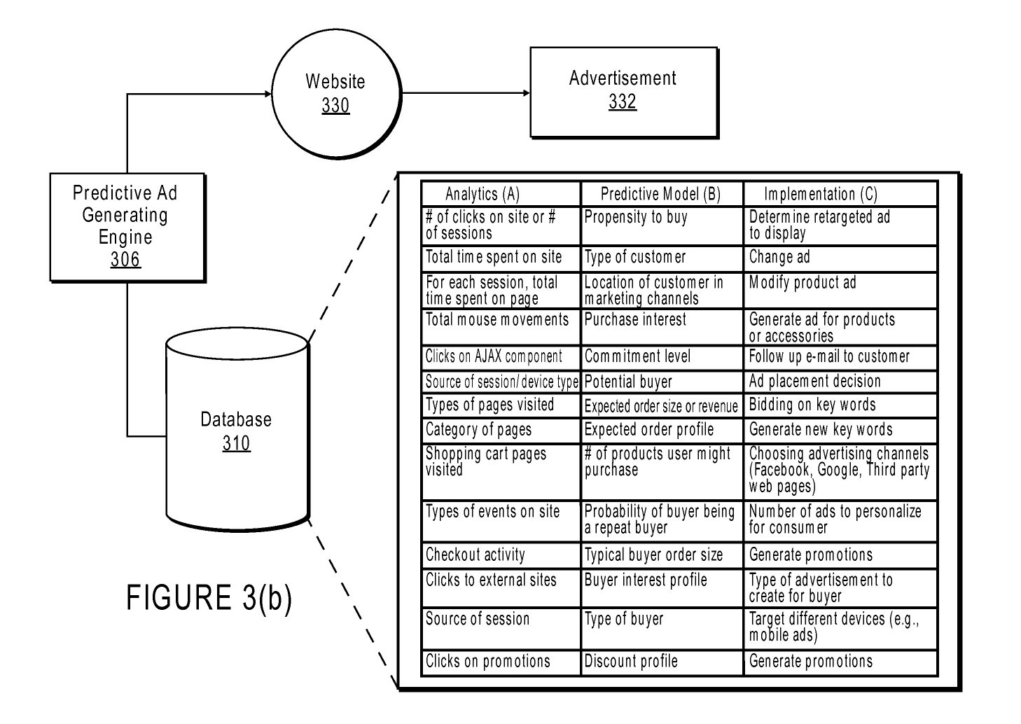

It will be appreciated that the advertising analytics server 304, e-commerce Web site 312, third party Web sites, 330 and 334, search engine 324, merchant 316 and clients 318 (shown in FIG. 3) can be implemented in computer system 100, by way of either a client machine, server machine, or some combination of servers, clients and other network devices known to one of ordinary skill in the art.

The various databases described herein and illustrated, e.g., in FIGS. 3(a)-(b) are computer-based record keeping systems. Stated differently, these databases are each a combination of computer hardware and software that act together to allow for the storage and retrieval of information (data). Accordingly, they may resemble computer system 100, and are often characterized by having storage mediums capable of accommodating significant amounts of information.

FIG. 2 illustrates a computer system 200 from the point of view of its software architecture, according to embodiments of the invention. Computer system 200 may be a server or a group of servers or computers. The various hardware components of computer system 200 are represented as a hardware layer 202. An operating system 204 abstracts the hardware layer and acts as a host for various applications in application layer 206. The network and communications protocol layer implements the protocols (e.g., HTTP, HTTPS, and SSL) necessary for the devices to communicate over the network. Systems components such as advertising analytics server 304, e-commerce Web site 312, search engine 324 and third party Web sites such as 330 and 334 and clients 318, may be implemented in a computer system, such as computer system 200.

The computer systems 100 or 200 may also include Web server applications which provides Internet access for the client computers via Web browsers. In the case of a client system, the operating system acts as a host for Web browser applications. The search engines 324 and third party Web sites 330 may also be implemented by way of computer systems 100 and 200. It will be appreciated by one of ordinary skill in the art that the computer systems described herein can operate in a manner consistent with the Open Systems Interconnection (OSI) model.

To better understand the context in which predictive or personalized advertising may be employed, consider advertising system 300 illustrated in FIGS. 3(a) and 3(b).

Included in system 300 is advertising analytics server 304, network 302. e-commerce Web site 312, clients 318(a)-(c), search engine 324, and third party Web sites 330 and 334. The various constituents of system 300, including advertising analytics server 304, e-commerce Web site 312, clients 318, search engine 324 and third party Web sites 330 and 334 are communicatively coupled to one another via one or more computer/data networks 302, which may include the Internet and other networks coupled thereto. The various computers, servers, routers, gateways, fiber optic cables, firewalls, wireless communication devices, radio towers and other networking devices which make up of network 302 and their precise hardware and software configurations is generally not critical to the present invention.

According to one embodiment of the invention, the advertising analytics server 304 is a central component of advertising system 300. The advertising analytic server may also include predictive ad generating engine 306 and ad personalization engine 308. The advertising analytics server 304 may also include database 310, which stores consumer information, search histories, search analytics, etc. In one embodiment, the advertising analytics server and its constituent engines implement the algorithms and programs described herein to generate advertising for e-commerce Web sites 312 using direct feedback from online consumer behavior data (analytics) stored in database 310. The advertising analytics server is capable of communicating directly or indirectly with e-commerce Web sites 312, clients 318, search engines 324, arid third party Web sites 330 and 334 to place ads on behalf of an e-commerce Web site 312 and e-commerce merchant, shown here as merchant 316.

In certain embodiments, the advertising analytics server 304 utilizes data measurements across a number of different factors and implements specific business intelligence algorithms using the predictive ad engine 306 or ad personalization engine 308 when certain data thresholds or levels of activity are reached. For example, consider a situation where there are 100 visits to a registered e-commerce Web site in any given time period. The analytics server is able to measure the frequency and duration of each visit. The analytics server is also capable of recording the types of pages visited, the types of products, browsed, time spent on each page, Web page entry points and exit points, order size, order amount, etc. Based on these analytics, which may be stored in the analytics server and/or database 310, the predictive ad generating engine is able to apply a specific Predictive Model to implement a specific advertising campaign as shown below in Table 1.

From left to right, Table 1 shows how Analytics data (A), coupled with Predictive Model (B), can result in a specific advertising Implementation (C).

TABLE 1

| Analytics (A) | Predictive Model (B) | Implementation (C) |
|---|---|---|
| # of clicks on site | Propensity to buy | Determine retargeted |
| or # of sessions | | ad to display |
| Total time spent | Type of customer/ | Change ad/Bidding |
| on the site | Keyword quality | on keywords |
| For each session, | Location of customer in | Upsell/Modify |
| total time | marketing channels | product ad |
| spent on page | | |
| Total number | Purchase interest | Generate ad for |
| of mouse | | products or |
| movements | | accessories/offer |
| | | deals |
| Clicks on products | Commitment level | Follow-up email to |
| | | customer |
| Sounce of session/ | Potential buyer | Ad placement |
| device type | | decision |
| Types of pages | Expected order size or | Bidding on key words |
| visited | revenue | |
| Category of pages | Expected order profile | Generate new key |
| | | words |
| Shopping cart pages | # of products user might | Choosing advertising |
| visited | purchase | channels (Facebook, |
| | | Google, Third party |
| | | Web pages) |
| Types of events on | Probability of buyer | Number of ads to |
| site | being a repeat buyer | personalize for |
| | | consumer |
| Checkout activity | Typical buyer or size | Generate promotions |
| Clicks to external | Buyer interest profile | Type of |
| sites | | advertisement to |
| | | create for buyer |
| Source of session | Type of buyer | Target different |
| | | devices (e.g., mobile |
| | | ads) |
| Clicks on | Discount profile | Generate promotions |
| promotions | | |

According to various embodiments of the invention, this database table may be implemented in database 310 by predictive ad generating engine 306 to generate e-commerce and personalized advertisements. It will be appreciated that the data points of Analytics (A) can be implemented with different combinations of Predictive Model (B), to result in different implementations of (C). By rendering various statistical calculations in the analytics server, the advertising analytics system is able to make automated decisions and act on information that is valuable to the e-commerce business, such as providing real-time information to the merchant on whether a consumer is likely to buy a product, the revenue to expect from a particular type of consumer, the expected order size to receive from a particular type of consumer, etc. This information allows the merchant 316 and/or the predictive ad generating engine 306 and ad personalization engine 308 to adjust its predictive algorithms, and hence the actual advertising itself.

In one embodiment, the advertising analytics server receives information, instructions, or data from e-commerce Web site 312, including, for example, real-time analytics data transmitted by analytics software 314. It will be appreciated that the advertising analytics server can receive information on the products, services and content of the e-commerce Web sites that are registered or affiliated with advertising analytics server 304. In some embodiments, the advertising analytics server deploys crawlers, spiders or other scripts to gather, index and analyze the content of e-commerce Web site 312 for use in predictive ad generation and processing.

The predictive ad generating ad engine 306 of advertising analytics server may process and generate ads on behalf of merchant and e-commerce Web sites and communicate such ads directly to clients 318, third party Web sites 330 and 334 and/or search engine 324. The predictive ad generating engine 306 uses predictive models such as those shown in Table 1 to calculate such factors as propensity to buy, type of customer, order size, buyer interest, type of buyer, discount profile, etc. Based on the profile and model created for each consumer (or type of consumer), the e-commerce business may target consumers by creating specific advertisements for consumers or categorized groups of consumers and redirect advertisements to sites where there is a statistical likelihood that the consumer will visit or purchase items.

In one embodiment the ad personalization engine 308, may customize and personalize ads for consumers and potential consumers by retrieving data on the consumer or potential consumer and generating ads targeted towards the individual consumer connected to the advertising system via clients 318(a)-(c). This implementation may be used to redirect ads to consumers based on their browsing activity or to target ads to Web pages frequently visited by the consumer. For example, consider a situation where a browser enters an e-commerce site looking to purchase a tennis racquet. Based on the activities of the user in searching, retrieving and browsing product pages related to tennis racquets and related items, the analytics server is able to categorize the user with an interest in sports and tennis. After visiting the e-commerce site, the consumer may then decide to browse the Web page for the NYTimes to catch up on new or sports. The analytics server is able to register this activity and store this particular's consumer preference for the NYTimes Web Page. Accordingly, for this particular user, the analytics server and the ad personalization engine may create an ad for the e-commerce Web site, and in particular, for tennis racquets. The advertising analytics server may also simultaneously make a purchase request for ad space on the NYTimes Web Page. The advertising analytics server may also specify to the NYTimes ad services that the ad for its tennis racquets should only be placed whenever this particular user visits a NYTimes Web page. The advertising analytics server may also place a budget for the advertising and specify the number of times the ad should appear for any given user. Using this method, for example, an e-commerce site is able to direct thousands of ads that are targeted, personal and likely to be viewed by visitor of the e-commerce Web site.

In one embodiment, the advertising analytics server may also communicate advertising instructions to search engine 324 which may itself generate ads through its advertising engine 326, and make such ads visible and searchable by clients 318(a)-9c).

In another embodiment, the advertising analytics server transmits or installs analytics (advertising) software 314 on e-commerce Web site. This application may consist of scripts, cookies, and/or other files that allow e-commerce Web sites 312 and merchant 316 to communicate and keep information updated between advertising analytics server and the e-commerce Web site 312.

According to one embodiment, the advertising analytics server 304 places a cookie or monitoring file on clients 318(a)-(c) on behalf of e-commerce Web site 312 or search engine 324. The analytics server may also track the activity of clients 318 using IP addresses or other identifiers. The advertising analytics server may also cause search engine 324 to place a cookie or monitoring file on clients 318. The cookie or monitoring file transmits information on consumer behavior, Web sites visited, products browsed, time spent on Web page, or any other analytics data shown for example in Table 1(A). The cookie or monitoring file and the associated analytics data which is transmitted to database 310 or search engine database 328 may be used by advertising analytics server 304 to create the appropriate and customized ad for e-commerce Web site 312 and merchant 316.

As shown in the embodiment in FIG. 3(a), the advertising analytics server 304 can communicate directly with clients 318, or via e-commerce Web site 312, which are visited by clients 318. The advertising analytics server may generate predictive or personalized ads 322(a)-(c) and cause such ads to appear in the Web browsers of other application programs (e.g., in application ads) of clients 318 when they access Web pages 320(a)-(c). The ads may be placed on the e-commerce Web site, third party Web sites, and or appear in search engine search results, whenever a client 318 uses a Web browser that has the associated monitoring file or cookie. It will also be appreciated that the client 318 need not necessarily visit e-commerce Web site 312 which is registered with advertising analytics server 304 in order to receive predictive advertising. In certain embodiments, the advertising analytics server 304 may be included in or associated with search engine 324 and advertising engine 326. In these situations, the search engine 324 may itself place the monitoring file or cookie on the clients 318. Hence, the e-commerce Web site and merchant 316 seeking a predictive advertising campaign, may be registered or affiliated directly with search engine provider 324 and associated advertising engines 326, in order to utilize the services of advertising analytics server 304.

As discussed, in one embodiment, the advertising analytics server 304 may place ads directly on third party Web sites 330 and 334 in response to analytics data and the implementation of predictive models. The advertising analytics server may cause ads 332 to appear on third party Web sites 330 as ads 332 and 336, and/or specifically on Web pages 320 in the form of ads 322(a)-(c). The advertising analytics server 304 may customize and personalize such ads on the consumer's Web pages by gathering and analyzing data received by cookies and monitoring files from consumer's Web browsers. For example, consider a user that has a Facebook, LinkedIn, Google, Yahoo!, Microsoft™, Netflix™, or other type of third party account, that provides customized content for consumers. The advertising analytics server may communicate ads directly to the content page of these third party sites whenever a consumer logs into his or her account, be it email, social networking pages, movie lists, content pages, etc. The advertising analytics server is able to transmit personalized and relevant ads on behalf of the e-commerce merchant and Web site 312, by placing ads 322(a)-(c) on the Web pages 320(a)-(c) of clients 318. It will also be appreciated that the advertising analytics server can strategically and effectively place ads on third party Web sites 330 that a user has visited in the past. In this case, the e-commerce Web site is likely to have its link or advertisement placed on a page such as NYtimes.com, CNN.com and others that are visited by the potential consumer. Moreover, the analytics server and predictive ad generating engine 306 or ad personalization engine 308 are able determine a specific type of ad, product ad, promotion, etc., that is based on the predictive models implemented by the advertising analytics system.

In one embodiment of the present invention, the advertising analytics server 304 is also a data mining center that is capable of receiving information from third party Web sites 330 and 334, databases, and other information centers in order to monitor general consumer trends or activity on the Internet. For example, as discussed earlier, the advertising analytics server can measure user activity related to certain products or Web sites and implement predictive advertising campaigns on behalf of e-commerce Web site 312.

In one embodiment, e-commerce Web site 312 is hosting one or more e-commerce Web sites. E-commerce Web site 312 may also consist of a plurality of different e-commerce Web sites. Each Web site may include one or more Web pages. As mentioned above, the Web sites may be commerce sites in which visitors are engaged in some sort of on-line commerce, but the present invention is not restricted to use in connection with such sites. Hence, the Web pages may he associated with social networking sites, forums, blogs, content sites, etc. An e-commerce Web site may be setup by merchant, administrator 316 or a business owner or any other person interested in selling products and services on-line. Examples of e-commerce Web sites include those operated by Amazon.com. Overstock.com™ and E-bay.com™. However, it will be appreciated that present invention can be used with e-commerce Web sites operated by small businesses or individuals selling products or services on-line. The e-commerce server 302 may include Web page applications, Web pages, and e-commerce software for facilitating transactions with consumers on-line, however, in some cases aspects of these services will he hosted on other servers. For example, payment services may be facilitated through servers operated by payment fulfillment providers. Such details are not critical to the present invention. In general it is sufficient for purposes of the present discussion to assume that the e-commerce server includes a Web server (or Web applications) for hosting the e-commerce Web site's product Web pages. Usually, the e-commerce server 312 will also include or be associated with a database for storing customer and product information.

According to certain embodiments, the e-commerce Web sites 312 are accessed by users via client systems 318a-318c. The client systems may, in some cases, be computer systems, such as personal computers or the like, but more generally may be any computer-based or processor-based device that executes application software or embedded routines which allows the content of the Web site to be rendered for display to the user on a display device. For example, client systems may include computer systems, mobile devices such as tablets, iPads™, smart phones, mobile phones, etc., and the application software may be a Web browser. Such applications are typically stored in one or more computer readable storage devices accessible to one or more processors of the subject, client system and, when executed, cause the processor(s) to perform the operations necessary to render the subject sites/pages for display at the subject system (e.g., via a display device communicatively coupled to the processor).

The advertising analytics server 304 may store information on customers or visitors of e-commerce Web site, such as products previously purchased, previous visits to the Web site, pages accessed and viewed, and any other useful information on the customer such as product preferences, etc. This information may be stored in a database 310 for later data mining and customization of advertising delivered to customers and consumers. In one embodiment, the advertising analytics server communicates real time information concerning these customers and visitors and their activities at the e-commerce Web site 312 and merchant administrator 316. This telemetry is facilitated via a cookie placed on the customer's/visitor's computer device.

The Web browsers used in embodiments of the invention may include, for example, Microsoft Explorer™, Fire Fox™, Netscape Navigator™, Apple Safari™ and Google Chrome™. The Web browsers may be configured to allow the receipt of cookies and/or other files for monitoring the activities of Web browsers and/or clients 318a-c as they visit the e-commerce Web site, third party sites, and/or search the Internet generally. As shown and depicted in FIG. 3, clients 318a-c are capable of receiving and displaying Web pages 320(a)-(c) and associated ads 322a-c.

In one embodiment, if the customer is visiting the e-commerce Web site 312 for the first time, the analytics software 314 and/or other software or application on the e-commerce Web site is notified of the new customer (which may be identified by its client Internet Protocol (IP) address, computer media access control (MAC) address, registration information, or other information) that identifies the client 318 as a new customer or visitor of the e-commerce Web site. The customer information will be stored at the advertising analytics server and/or an e-commerce server associated with e-commerce Web site 312. It will also be appreciated that each time a new customer or previous customer visits the registered or affiliated e-commerce Web site the advertising analytics server 304 receives notification of the customer activity. For example, cookies, or other software may be installed or present on customer client devices that communicate directly with the advertising analytics server, conveying such information as pages visited, browsed, products viewed, products purchased and searches and other third party Web sites visited by the client 318.

It will be appreciated that clients 318(a)-(c) may have Web browsers which may periodically or upon command delete cookies or other files received from the Internet. Accordingly, embodiments of the present invention allow the e-commerce Web site 312 and/or advertising analytics server 304 to transmit the cookie or monitoring file to the client 318 each time a consumer accesses the Internet through one or more search engines 324. This will ensure that the advertising analytics server can receive information on the activities of consumers visiting an e-commerce Web site or any other Web site for that, matter. In other embodiments, the e-commerce Web site may enable the use of cookies on the consumer's client device, depending on whether the use of cookies or other Internet files that transmit information over a network is enabled on the device. One or more system components may also prompt the consumers and/or clients 318 to turn on cookies when the user visits the e-commerce Web site 312 or uses search engine 324 in order to ensure personalized advertisements are delivered to the user on behalf of e-commerce Web site 312 and/or merchant 316.

In other embodiments, it may not be necessary to employ a cookie or monitoring file to transmit information from a consumer using client 318 to the advertising system 300. It is also possible that the consumer visiting an e-commerce Web site or search engine 324 can register with the Web site or search engine and obtain a user name/password for subsequent recognition by the e-commerce Web site or search engine. In this situation, the advertising analytics server 304 can track the user's real time consumer activity through the login sessions with or without cookies being transmitted to the user's computer.

Also shown in FIG. 3(a), is merchant 316. In one embodiment, the merchant 316 is the merchant who owns or operates the e-commerce Web Site 312. The merchant administrator may access the services of the advertising analytics server 304 using any suitable computing devices with a network connection, such as desktop, laptop or mobile computing device connected to the Internet. In one embodiment, the communications between the merchant 316 and the advertising analytics server are bi-directional. It will be appreciated that in certain embodiments, the merchant may be able to track and monitor the location and types of ads being generated from the e-commerce Web site as well as real-time information on the amount of expenditures incurred for the predictive advertising campaign. Using an interactive user interface, the merchant may be able communicate preferences and modifications to the advertising models implemented by the advertising analytics server 304. The merchant administrator may log into the advertising analytics server using a unique user name and password provided by the advertising analytics system. In one embodiment, the merchant administrator uses a Web browser to access the advertising analytics server. In other embodiments, the merchant administrator may use an application residing on the merchant's computing device that communicates with advertising analytics server and/or e-commerce Web site operating analytics software 314.

FIG. 3(a) also depicts a search engine 324. It will be appreciated that search engine 324 is exemplary and may be represented by one or more search engines. Examples of some commonly used search engines include Google, Yahoo! and Microsoft Bing. The search engine 324 may also include advertising engine 326 for generating ads 322. As discussed above, and as shown in FIG. 3, in one embodiment the search engine 324 and/or its corresponding advertising engine 326 establishes bi-directional network communications with advertising analytics server 304. The search engine 324 may receive instructions from advertising analytics server 304 to generate predictive advertisements for e-commerce sites or personalized or customized content for clients 318 that include targeted advertising for e-commerce Web site. The search engine 324 may also generate ads 322 in the form of pop-up ads, audio-visual ads or audio ads for the merchant 316 and/or e-commerce Web site 312. These ads may appear in the search engines search results pages, content pages, shopping pages, or any other Web pages that are designated by advertising analytics server 304. The search engine may also include a search engine database 328 which stores information on users of the search engine, their shopping habits, product preferences. Web sites visited, etc, for later transmission to advertising analytics server 304. In one embodiment, the advertising analytics server 304 may bid on certain search terms with search engines 324 and ad channels such as Google, Yahoo!, or Microsoft Bing.

Also shown in FIG. 3(a) are third party Web sites 330 and 334. The third party Web sites may include popular social networking Web sites such as Facebook, Google LinkedIn, popular shopping Web sites such as Amazon.com and/or any other Web Site suitable for placing ads for e-commerce Web site 312. In one embodiment, the advertising analytics server may place ads 332 and 336 on third party Web sites based on a predictive model, and data analysis of consumer behavior. In another embodiment, ads 332 and 336 may appear on affiliated or n on-affiliated Web sites that are likely to be browsed by the consumer using client 318. For example, in one embodiment, the advertisement analytics server alone, or in conjunction with advertising engine 326 may place ads on Web sites frequently visited by the user, or in some cases may predict which Web sites a user may actually visit.

FIG. 3(b) depicts an enlarged system view of the predictive ad generating system according to an embodiment of the invention. As shown here, the database 310 includes the predictive algorithms and rules (Table 1) for implementing an advertisement according to embodiments of the invention discussed herein. The predictive ad generating engine 306 draws on the rules and models in database 310 to generate an advertisement 332 on Web site 330. It will be appreciated the system may combine any of the particular analytics shown in column 1 of Table 1 to generate predictive models and combinations that account for multiple factors. For example, the time spent on a Web Site factored with the number of mouse clicks on a certain Web page may trigger the predictive algorithm that classifies the buyer as one highly interested in the contents of the e-commerce Web site, and in particular, a certain product on that Web site. Thus, the advertising implementation, taking into account both of these factors, may generate an advertisement that features the e-commerce Web site of interest and also particular products of interest to that user. Furthermore, it will be appreciated that predictive ad generating engine may have a learning component that can modify the user classification and predictive model, and hence change the advertising implementation based on the new data.

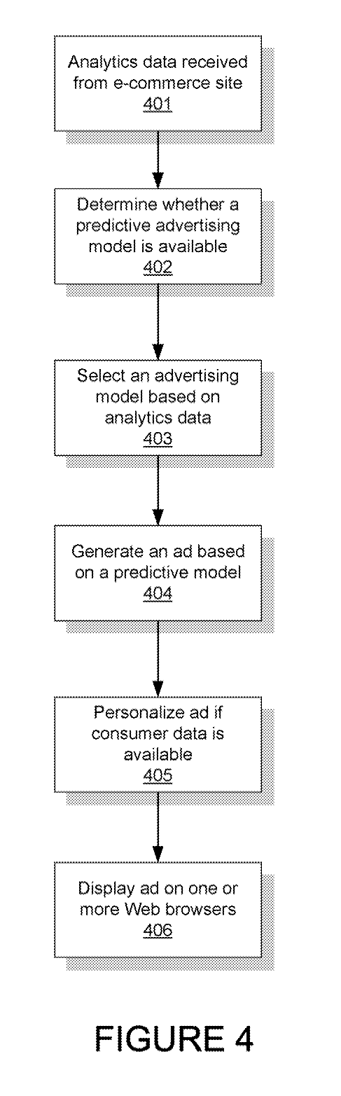

FIG. 4 depicts a method for generating an advertisement according to one embodiment of the invention. In step 401, the method starts with receiving analytics data from one or more e-commerce Web sites. In step 402, a determination is made as to whether a predictive advertising model is available for a given set of analytics data. In step 403, assuming there is a predictive model available, an advertising model is selected based on the analytics data. In step 404, an advertisement is generated based on the selected model. Optionally, keyword bids may also be revised, or the user behavior is manifested in a form that would help make decisions in the future. In step 405, which may be optional, a determination is made whether to personalize the ad if specific consumer data is available. In step 406, the advertisement is placed on one or more Web sites. In the alternative, the advertisement may appear in the user's Web browser.

As should be apparent from the foregoing discussion, various embodiments of the present invention may be implemented with the aid of computer-implemented, processes or methods (i.e., computer programs or routines) or on any programmable or dedicated hardware implementing digital logic. Such processes may be rendered in any computer language including, without limitation, a object oriented programming language, assembly language, markup languages, and the like, as well as object-oriented environments such as the Common Object Request Broker Architecture (CORBA). Java™ and the like, or on any programmable logic hardware like CPLD, FPGA and the like.

It should also be appreciated that the portions of this detailed description that are presented in terms of computer-implemented processes and symbolic representations of operations on data within a computer memory are in fact the preferred means used by those skilled in the computer science arts to most effectively convey the substance of their work to others skilled in the art. In all instances, the processes performed by the computer system are those requiring physical, manipulations of physical quantities. The computer-implemented processes are usually, though not necessarily, embodied the form of electrical or magnetic information (e.g., bits) that is stored (e.g., on computer-readable storage media), transferred (e.g., via wired or wireless communication links), combined, compared and otherwise manipulated. It has proven convenient at times, principally for reasons of common usage, to refer to these signals as bits, values, elements, symbols, keys, numbers or the like. It should be borne in mind, however, that all of these and similar terms are to be associated with the appropriate physical quantities and are merely convenient labels applied to these quantities.

Unless specifically stated otherwise, it should be appreciated that the use of terms such as processing, computing, calculating, determining, displaying or the like, refer to the action and processes of a computer system, or similar electronic computing device, mat manipulates and transforms data represented as physical (electronic) quantities within the computer system's registers, memories and other storage media into other data similarly represented as physical quantities within the computer system memories, registers or other storage media. Embodiments of the present invention can be implemented with apparatus to perform the operations described herein. Such apparatus may be specially constructed for the required purposes, or may be appropriately programmed, or selectively activated or reconfigured by a computer-readable instructions stored in or on computer-readable storage media (such as, but not limited to, any type of disk including floppy disks, optical disks, hard disks, CD-ROMs, and magnetic-optical disks, or read-only memories (ROMs), random access memories (RAMs), erasable ROMs (EPROMs), electrically erasable ROMs (EEPROMs), magnetic or optical cards, or any type of media suitable for storing computer-readable instructions) to perform the operations. Of course, the processes presented herein are not restricted to implementation through computer-readable instructions and can be implemented in appropriate circuitry, such as that instantiated in an application specific integrated circuit (ASIC), a programmed field programmable gate array (FPGA), or the like.

It should be appreciated that the embodiments described above are cited by way of example, and that the present invention is not limited to what has been particularly shown and described hereinabove. Rather, the present invention includes both combinations and subcombinations of the various features described hereinabove, as well as variations and modifications thereof which would occur to persons skilled in the art upon reading the foregoing description and which are not disclosed in the prior art.

What is claimed is:

1. An automated advertising system, comprising:
an advertising analytics server communicatively coupled to one or more e-commerce servers, one or more search engines, one or more Web sites and one or more Web browsers;
said advertising analytics server capable of receiving analytics data from one or more e-commerce servers; wherein said analytics data includes data from the activities of said one or more Web browsers;
wherein said advertising analytics server further comprises a predictive ad generating engine and one or more predictive ad generating algorithms;
wherein said predictive ad generating engine utilizes analytics data from one or more e-commerce servers and generates one or more ads on behalf of said e-commerce servers using at least one ad generating algorithm;
wherein said advertising analytics server causes said ad to be placed on at least one of said browsers.

2. The system of claim 1 wherein said advertising analytics server is coupled to a search advertising engine and bids on key words with said advertising search engine.

3. The system of claim 1 wherein said advertising analytics server contains analytics data and predictive models to classify user behavior, the predictive models being used by the predictive ad generating engine to create a personalized ad.

4. The system of claim 3 wherein said advertising analytics server communicates directly with one or more Web sites and causes an ad to be displayed on one or more Web sites that are selected based on said predictive model and said predictive ad generating algorithm.

5. A method for effecting automated advertising over a network, comprising:
receiving analytics data from one or more e-commerce Web sites;
determining whether an ad generating algorithm is available for a given set of analytics data;
if an ad generating algorithm is available, selecting at least one ad generating algorithm based on a given set of analytics data;
generating an ad based on at least one ad generating algorithm; and
causing said advertisement to be displayed on at least one Web browser.

6. The method of claim 5 further comprising the step of an analyzing analytics data in connection with one or more predictive models before selecting at least one ad generating algorithm that is based on a classification of analytics data to one or more predictive models.

7. The method of claim 5 further comprising the step of bidding on key words in response to receiving analytics data from one or more e-commerce Web sites.

8. The method of claim 5 further comprising the step of personalizing the ad for the recipient of the ad.

9. A method of bidding on key words with a search engine, comprising:
monitoring the behavior of users on one or more Web sites;
collecting analytics data based on behavior of users on one or more Web sites;
comparing the user behavior to a predictive model to determine a factor related to products and services;
identifying one or more key words based on said factor;
bidding on one or more identified keys words with said search engine.

10. The method of claim 9, further comprising optimizing the bid amounts based on a pre-determined advertising budget.
